(19) United States
(12) Patent Application Publication
(10) Pub. No.: US 2022/0134971 A1
(43) Pub. Date: May 5, 2022

(54) Support Plates and Systems for Supporting a Liquid Dispenser Assembly, and Liquid Dispenser Apparatuses

(71) Applicants: Ronald El Cheikh, Greenvale (AU); Pierre EL Cheikh, Kurnell (AU)

(72) Inventors: Ronald El Cheikh, Greenvale (AU); Pierre EL Cheikh, Kurnell (AU)

(73) Assignee: The Sheek & Co,, Greenvale (AU)

(21) Appl. No.: 17/094,130

(22) Filed: Nov. 10, 2020

(30) Foreign Application Priority Data
Nov. 2, 2020 (CN) 202022492642.1

(51) Int. Cl. B60R 15/00; B60R 11/00

(52) U.S. Cl. CPC B60R 15/00; B60R 11/00; B60R 2011/0084; B60R 2011/0017; B60R 2011/0059; B60R 2011/0008

(57) ABSTRACT

Herein provided is a support plate that is configured for supporting a liquid dispenser assembly, wherein a first side of the support plate includes a lever lock system configured to attach to an air vent of a vehicle; the lever lock system including: a rod protruding from the first side of the support plate; a hook at an end of the rod remote from the support plate; a spring that is compressible along the rod towards the support plate; and a bracket member, wherein the bracket member may be moved along the rod towards and away from the support plate, between an open position wherein the spring is compressed and the bracket member is distant from the hook, and a closed position wherein the bracket member is pushed towards the hook by the spring, further provided herein is a support system that is configured for supporting a liquid dispenser assembly and includes a lock system configured to attach to a headrest of a vehicle.

Application also pending in China, Application #202022492642.1, filing date 2020 Nov. 2

### TECHNICAL FIELD

The present invention relates generally to supports for a liquid dispenser apparatus, and liquid dispenser apparatuses comprising the support, in particular hand sanitizer dispensers, and more particularly to a support plate and a hand sanitizer dispenser apparatus configured for mounting in a vehicle.

### BACKGROUND

The COVID-19 pandemic has made people more aware of the risk of transmitting bacteria and viruses through their hands, where even the mere act of handshaking, holding knobs and documents pose great risk in transferring or getting infected by high contagion like COVID-19. Thus, liquid such as alcohol concentrates, hand sanitizers, soaps, and other disinfectants have become an essential part of our daily lives to go outdoors and into common areas.

Workplaces, public areas, and transport vehicles are all common areas. In particular, vehicles are one of the places where people may leave behind bacteria or viruses, or pick up bacteria or viruses that may have been transferred through clothes, shoes, or even objects. People spend significant time in vehicles and use their hands for almost everything. Although sanitizing vehicles with any other disinfectants may help in killing viruses and bacteria, the main way to get infected by bacteria or viruses is through our hands, and this is the reason why health officials suggest frequent hand washing.

Vehicles lack the ability to secure a location for a liquid dispenser such as a hand sanitizer dispenser. Hand sanitizer dispensers can be large and heavy, and thus difficult to secure in a stable fashion for dispensing within a vehicle. Passengers may bring individual hand sanitizer dispensers, such as small individual dispensers, but this poses another problem since passing on small sanitizers from one hand of a passenger to another or dropping the sanitizer on car mats also poses a source of bacteria and viruses. The lack of secured position of undisturbed, properly mounted sanitizing dispensers in vehicles is a problem that may just expose more people to danger in getting viruses from public or even private vehicles. The availability of dispensers to disinfect hands with less use of hands in handling sanitizers is scarce or non-existent within vehicles.

### SUMMARY

To overcome one or more of the problems in the art, the present invention provides support plates, systems for a liquid dispenser apparatus that can be mounted with stability and reliability in a vehicle, and liquid dispenser apparatuses that can be mounted with stability and reliability in a vehicle.

In an aspect, a support plate for a liquid dispenser apparatus is provided. The liquid dispenser apparatus can be, e.g., an automated hand sanitizer dispenser apparatus configured for contactless dispensing of a hand sanitizer. The support plate is characterized in that it is configured for supporting a liquid dispenser assembly; wherein a first side of the support plate includes a lever lock system configured to attach to an air vent of a vehicle; the lever lock system including a rod protruding from the first side of the support plate; a hook at an end of the rod remote from the support plate; a spring that is compressible along the rod towards the support plate; and a bracket member, wherein the bracket member may be moved along the rod towards and away from the support plate, between an open position wherein the spring is compressed and the bracket member is distant from the hook, and a closed position wherein the bracket member is pushed towards the hook by the spring.

The hook may be separate from the rod, or integral with the rod. In an aspect, the hook may be configured to attach onto at least one flap of an air vent, and the spring and bracket member may be configured such that in a closed position, the spring compresses the bracket member against an opposite side of the at least one flap of an air vent for locking the support plate onto the air vent.

In an aspect, the first side of the support plate may further comprise at least one pad system for contacting a surface of a vehicle surrounding an air vent and thereby stabilizing the support plate. The at least one pad system may comprise a pad member that is adjustable in a horizontal direction towards and away from the support plate.

In an aspect, a liquid dispenser apparatus is provided, the liquid dispenser apparatus comprising: a dispenser assembly for dispensing a liquid; and a support plate configured to attach to the air vent of a vehicle as described herein.

The dispenser assembly may include a frame configured to support a liquid dispenser tank, such as an automated hand sanitizer dispenser tank configured for contactless dispensing of a hand sanitizer, the frame being configured to be attached to the support plate. A first side of the frame may include at least one lip configured to support the frame on the support plate. For example, the first side of the frame may include at least one lip extending horizontally along the width of the first side of the frame and at least one lip extending vertically along the length of the first side of the frame.

In an aspect, the support plate may include a second side opposite the first side, and the second side of the support plate may slide into the lips on the frame such that the lips at least partially surround at least three outer edges of the support plate for supporting the frame.

By providing a support plate for a liquid dispenser assembly and/or a liquid dispenser apparatus as described herein, the present invention can provide simple and easy installation of a liquid dispenser apparatus in an air vent of a vehicle with superior sanitization and hygiene capability. The liquid dispenser apparatus as described herein would not require passengers or drivers to touch or hold dispensers in their hand before getting liquids. The support plate is designed to clip onto an air vent of a vehicle. The lever lock system can add tension to support the liquid dispenser apparatus, and an adjustable pad system can provide additional support, stability, and controllability of positioning of the liquid dispenser apparatus, such as straightening and balancing against a dashboard of a vehicle. Thus, the support plate and/or liquid dispenser apparatus of the present invention can avoid disadvantages of the prior art, and can allow for dispensing of liquid, such as hand disinfectant, with less use of hands in handling the liquid dispenser apparatus.

In an alternative embodiment, a support system for a liquid dispenser apparatus is provided. The liquid dispenser apparatus can be, e.g., an automated hand sanitizer dispenser apparatus configured for contactless dispensing of a hand sanitizer. The support system is characterized in that it is configured for supporting a liquid dispenser assembly; wherein the support system comprises a support plate having a first side, and a lock system configured to attach to a headrest of a vehicle; the lock system including a mounting support arranged to be affixed to the first side of the support plate; and at least two clip attachments on the mounting support at an end remote from the support plate for attaching to headrest poles of a vehicle.

In an aspect, the at least two clip attachments can be actuated between an open position for receiving headrest poles of a vehicle and a closed position for holding securely to the headrest poles of a vehicle. The clip attachments may be adjustable to allow room for headrest poles with different sizes.

The mounting support may be separate from the support plate, assembled with or integral with the support plate. In an aspect, the first side of the support plate may comprise at least one protrusion and the mounting support may comprise at least one recess in a side thereof facing the first side of the support plate to receive the at least one protrusion such that the mounting support can be affixed to the support plate.

In an aspect, the first side of the support plate may further comprise a clamping system for stabilizing the mounting support. For example, the clamping system may comprise at least two walls protruding from the first side of the support plate and situated for clamping the mounting support therebetween. The protruding walls may be substantially parallel to each other, or in any suitable configuration for clamping.

In an aspect, a liquid dispenser apparatus is provided, the liquid dispenser apparatus comprising: a dispenser assembly for dispensing a liquid; and a support system configured to attach to the headrest of a vehicle as described herein.

The dispenser assembly may include a frame configured to support a liquid dispenser tank, such as an automated hand sanitizer dispenser tank configured for contactless dispensing of a hand sanitizer, the frame being configured to be attached to the support plate. For example, a first side of the frame may include at least one protruding section configured to connect to the support plate. For example, the protruding section can be a rectangular or other suitable shape configured to fit into the support plate.

In an aspect, the support plate may include a second side opposite the first side, and the second side of the support plate may include at least two lips, for example, an upper lip and a lower lip, configured to slide onto the protruding section on the frame such that the lips at least partially surround at least two outer edges of the protruding section for supporting the support plate on the frame.

By providing a support system for a liquid dispenser assembly and/or a liquid dispenser apparatus as described herein, the present invention can provide simple and easy installation of a liquid dispenser apparatus in a car seat headrest of a vehicle with superior sanitization and hygiene capability. The liquid dispenser apparatus as described herein would not require passengers or drivers to touch or hold dispensers in their hand before getting liquids. The support plate is designed to clip onto a car seat headrest of a vehicle. The lock system can support the liquid dispenser apparatus, especially adjustable clip attachments can apply to headrest poles with different sizes to provide support, stability, and controllability of positioning of the liquid dispenser apparatus. Thus, the support system and/or liquid dispenser apparatus of the present invention can avoid disadvantages of the prior art, and can allow for dispensing of liquid, such as hand disinfectant, with less use of hands in handling the liquid dispenser apparatus.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is an illustrative representation of a support plate, configured for supporting a liquid dispenser assembly, including a lever lock system configured to attach to an air vent of a vehicle in closed position in accordance with this invention;

FIG. 2 is an illustrative representation of a support plate, configured for supporting a liquid dispenser assembly, including a lever lock system configured to attach to an air vent of a vehicle in open position in accordance with this invention;

FIG. 3 is an illustrative representation of a support plate, configured for supporting a liquid dispenser assembly, further including a pad system for contacting a surface of a vehicle surrounding an air vent in accordance with this invention;

FIG. 4 is an illustrative representation of a frame of a dispenser assembly, the frame being configured to support a liquid dispenser tank and being configured to be attached to the support plate;

FIG. 5 is an illustrative representation of a frame of a dispenser assembly, the frame being configured with lips to be attached to the support plate;

FIG. 6 is an illustrative representation of a method of attaching a frame of a dispenser assembly to a support plate according to the present invention;

FIG. 7 is an illustrative representation of a support system configured for supporting a liquid dispenser assembly including a lock system configured to attach to a headrest of a vehicle in accordance with this invention;

FIG. 8 is an illustrative representation of a lock system configured to attach to a headrest of a vehicle including a mounting support and clip attachments;

FIG. 9 is an illustrative representation of a mounting support with adjustable clip attachments in accordance with this invention;

FIG. 10 is an illustrative representation of a support system configured for supporting a liquid dispenser assembly including protrusions and a clamping system in accordance with this invention;

FIG. 11 is an illustrative representation of a frame of a dispenser assembly, the frame being configured to support a liquid dispenser tank and being configured to be attached to the support plate;

FIG. 12 is an illustrative representation of a frame of a dispenser assembly, the frame being configured with lips to be attached to the support plate;

FIG. 13 is an illustrative representation of a method of attaching a frame of a dispenser assembly to a support plate and further to a lock system to attach to a car seat headrest according to the present invention.

In the drawings, like reference numerals are sometimes used to designate like structural elements. It should also be appreciated that the depictions in the figures are diagrammatic and not necessarily to scale.

### DETAILED DESCRIPTION

The present application will now be described in detail with reference to a few non-exclusive embodiments thereof as illustrated in the accompanying drawings. In the following description, numerous specific details are set forth in order to provide a thorough understanding of the present disclosure. It will be apparent, however, to one skilled in the art, that the present disclosure may be practiced without some or all of these specific details. In other instances, well known process steps and/or structures have not been described in detail in order to not unnecessarily obscure the present disclosure.

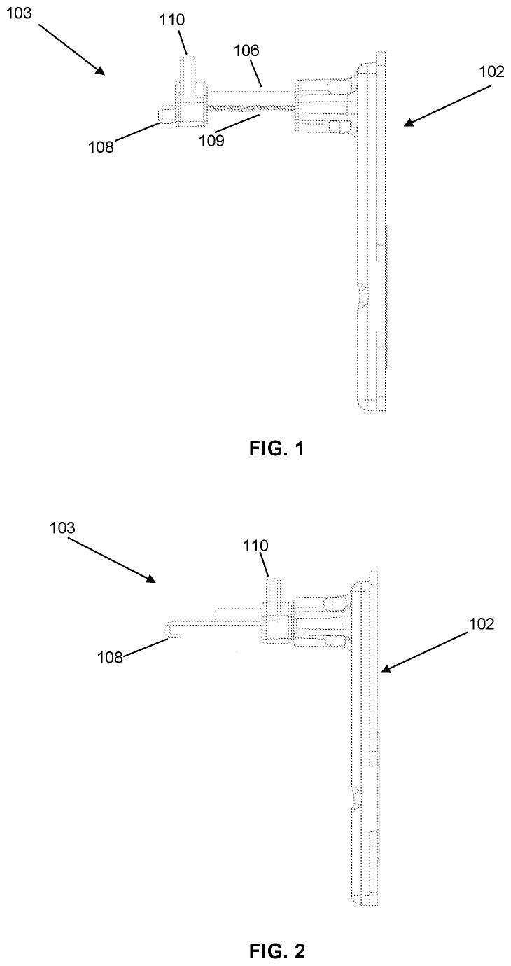

FIG. 1 is an illustrative representation of a support plate 102 that is configured for supporting a liquid dispenser assembly, the support plate including a lever lock system 103 configured to attach to an air vent of a vehicle in accordance with this invention. As shown in FIG. 1, the lever lock system is in a closed position.

FIG. 2 is an illustrative representation of support plate 102 as shown in FIG. 1, but with the lever lock system 103 in an open position.

With reference to FIGS. 1 and 2, the support plate 102 is configured with first side of the support plate 102 including the lever lock system 103 configured to attach to an air vent (not shown) of a vehicle. As shown in FIGS. 1 and 2, the lever lock system 103 includes a rod 106 protruding from the first side of the support plate 102; a hook 108 at an end of the rod 106 remote from the support plate 102; a spring 109 that is compressible along the rod 106 towards the support plate 102; and a bracket member 110, wherein the bracket member 110 may be moved along the rod 106 towards and away from the support plate 102. As shown in FIG. 1, the lever lock system 103 shows the bracket member 110 in a closed position wherein the bracket member 110 is pushed towards the hook 108 by the spring 109. As shown in FIG. 2, the lever lock system 103 is in an open position wherein the spring 109 is compressed and the bracket member 110 is distant from the hook 108.

The support plate 102 can be made of any suitable material, such as metal or plastic, and may be any dimension suitable for locking to an air vent of a vehicle. Preferably, the support plate is made of a lightweight plastic material.

The rod 106 can be made of any suitable material, preferably a metal. The hook 108 may be separate from the rod 106, or integral with the rod 106. In an embodiment, the hook 108 may be configured to attach onto at least one flap (not shown) of an air vent, and the spring 109 and bracket member 110 may be configured such that in the open position as shown in FIG. 2, the spring is compressed by the bracket member 110 to open a distance between the bracket member 110 and the hook 108 so as to allow the lever lock system 103 to be inserted into an air vent. The bracket member 110 can then be released such that it is advanced to a closed position as shown in FIG. 1, whereby the spring 109 compresses the bracket member 110 against an opposite side of the at least one flap of an air vent for locking the support plate 102 onto the air vent.

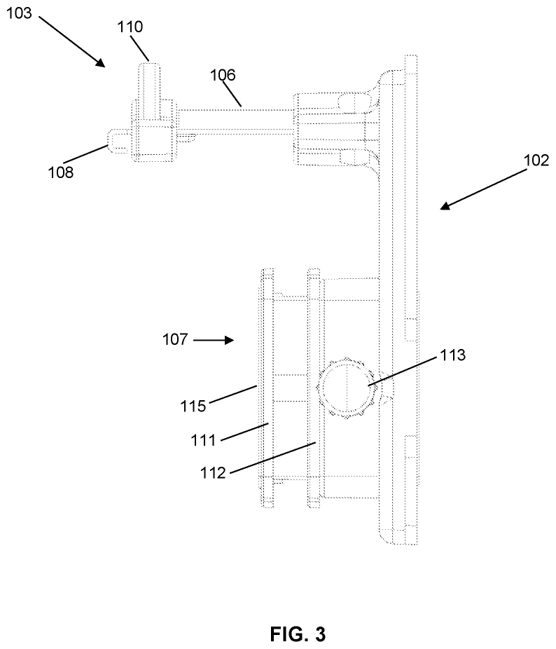

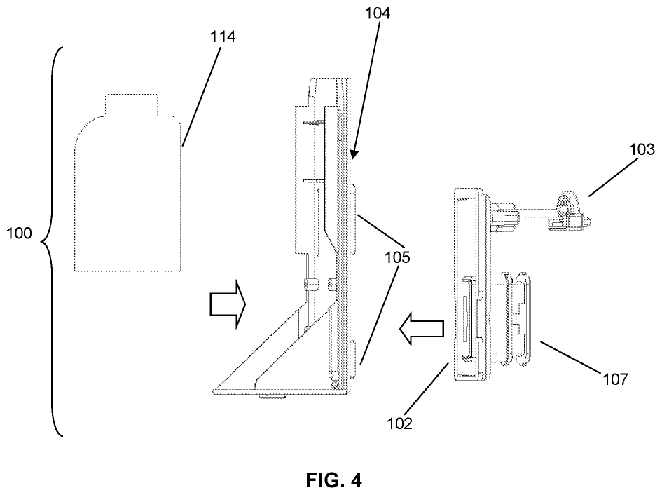

FIG. 3 is an illustrative representation of a support plate 102 as shown in FIGS. 1 and 2, the support plate further including a pad system 107 for contacting a surface of a vehicle surrounding an air vent in accordance with this invention.

In an embodiment with respect to FIG. 3, the first side of the support plate 102 may further comprise at least one pad system 107 for contacting a surface of a vehicle surrounding an air vent and thereby stabilizing the support plate 102. The at least one pad system 107 may be adjustable in a horizontal direction towards and away from the support plate 102. For example, the pad system 107 may include telescoping components that can be adjusted towards and away from the support plate 102.

In a preferred embodiment, the at least one pad system may comprise a telescoping locking mechanism for adjusting the length of the pad system in a horizontal direction towards and away from the support plate 102. For example, as shown in FIG. 3, the pad system may include at least one pad member 111 that telescopes with respect to a second pad member 112 that is integral with or affixed to the support plate 102, such that the pad member 111 may be actuated towards and away from the support plate 102. In embodiments described herein, the telescoping locking mechanism may be actuated by a knob 113, or other suitable mechanism. In an aspect, the telescoping locking mechanism may be adjustable and lockable to any angle to ensure an optimal dimension with the dashboard of a vehicle for optimal function and stability in a resting position. For example, the telescoping locking mechanism may be adjusted and locked to a substantially vertical dimension (e.g., a 90° angle, +/−10%) with the dashboard of the vehicle for optimal function and stability in a resting position. In any embodiment described herein, the pad system may include an optional cushioning surface for contacting a surface of a vehicle, such as a dashboard of a vehicle. The vehicle contacting cushioning surface may be affixed to the pad system at an area of the pad system that would contact a vehicle for cushioning and preserving the area of the vehicle being contacted. For example, the pad system as shown in FIG. 3 may optionally include a vehicle contacting cushioning surface 115 at the end of the pad member 111. The vehicle contacting cushioning surface may be made of a material such as EVA to cushion and preserve the area of the vehicle being contacted, such as the dashboard of a vehicle. The EVA material may be included in the pad system via any suitable means, such as by adhesive.

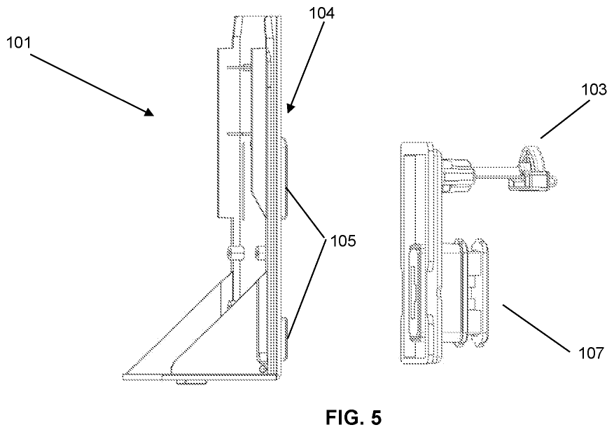

In an aspect, a liquid dispenser apparatus is provided, such as an automated hand sanitizer dispenser apparatus configured for contactless dispensing of a hand sanitizer, the liquid dispenser apparatus comprising the support plate 102 that is configured for supporting a liquid dispenser assembly that is described herein, the support plate 102 being configured, on the side opposite the lever lock system 103, to support a dispenser assembly 101. For example, as shown in FIG. 4, a liquid dispenser apparatus 100 may comprise a frame 104 of a dispenser assembly 101, the frame 104 being configured to support a liquid dispenser tank 114, such as an automated hand sanitizer dispenser tank configured for contactless dispensing of a hand sanitizer, and being configured to be attached to the support plate 102. The frame 104 can be attached to the support plate 102 by any suitable attachment mechanism, such as screws, bolts, etc.

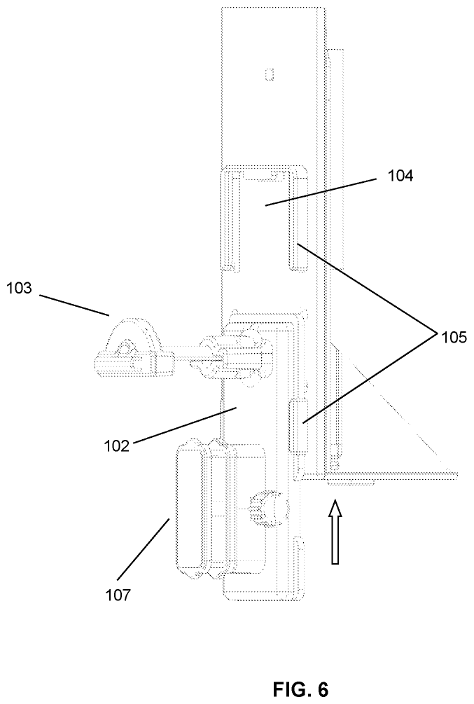

In an aspect, as shown in FIGS. 5 and 6, the frame 104 of a dispenser assembly 101 can be configured with lips 105 to be attached to the support plate 102. In an aspect, as shown in FIG. 5, a first side of the frame 104 may include at least one lip 105 configured to support the frame 104 on the support plate 102. For example, the first side of the frame 104 may include at least one lip 105 extending horizontally along the width of the first side of the frame 104 and at least one lip 105 extending vertically along the length of the first side of the frame 104. The lips 105 can at least partially surround the support plate 102, advantageously at least along the upper edge of the support plate 102. In an embodiment, the lips 105 could form a rectangle around the upper edge and corners of the support plate 102. Alternatively, the lips 105 could form other shapes, e.g., a T-shaped support, etc.

In an aspect, as shown in FIG. 6, a method of attaching a frame 104 of a dispenser assembly 101 to a support plate 102 according to the present invention comprises slipping the support plate 102 into lips on the frame 104. For example, the support plate 102 may include a second side opposite the first side, and the second side of the support plate 102 may slide into the lips 105 on the frame 104, for example, along the arrow as shown such that the lips 105 at least partially surround at least three outer edges of the support plate 102 for supporting the frame 104.

In an aspect, the liquid dispenser apparatus described herein can be an automated hand sanitizer dispenser apparatus configured for contactless dispensing of a hand sanitizer. For example, the dispenser assembly may be configured to include features such as a dispenser tank, a dispenser nozzle, a battery pack for providing power to the hand sanitizer dispenser apparatus, a hand sensor, an LED logo light that indicates when the hand sanitizer dispenser apparatus is operational, etc. One or more features of the dispenser assembly may be replaceable features, e.g., replaceable dispenser tanks, replaceable battery packs, etc.

By providing a support plate for a liquid dispenser apparatus 100 and/or a liquid dispenser apparatus 100 as described herein with reference to FIGS. 1-6, the present invention can provide simple and easy installation of a liquid dispenser apparatus in an air vent of a vehicle with superior sanitization and hygiene capability. The support plate enables a liquid dispenser apparatus as described herein to not require passengers or drivers to touch or hold dispensers in their hand before getting liquids. The support plate is designed to clip onto an air vent of a vehicle. The lever lock system can add tension to support the liquid dispenser apparatus, and an adjustable pad system can provide additional support, stability, and controllability of positioning of the liquid dispenser apparatus, such as straightening and balancing against a dashboard of a vehicle. Thus, the support plate and/or liquid dispenser apparatus of the present invention can avoid disadvantages of the prior art, and can allow for dispensing of liquid, such as hand disinfectant, with less use of hands in handling the liquid dispenser apparatus.

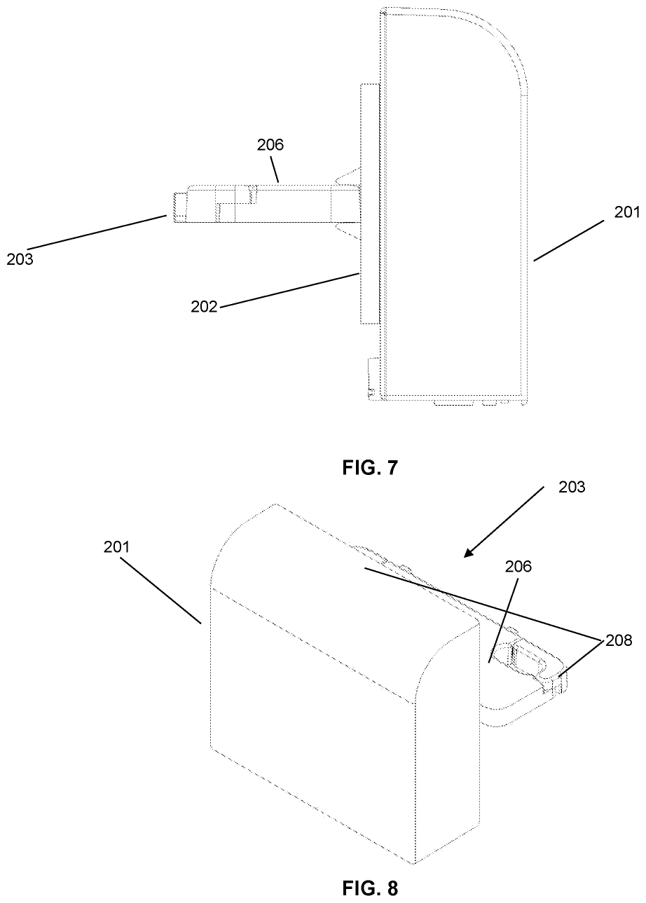

In an alternative embodiment, a support system for a liquid dispenser assembly is provided as shown in FIGS. 7-13, the support system being configured to attach to the headrest of a vehicle.

FIG. 7 is an illustrative representation of a support system that is configured for supporting a liquid dispenser assembly, the support system including a support plate 202 having a lock system 203 configured to attach to a headrest of a vehicle in accordance with this invention; and FIG. 8 is an illustrative representation of lock system 203 as shown in FIG. 7 including a mounting support 206 and clip attachments 208.

As shown in FIG. 7, a first side of the support plate 202 is configured to support a lock system 203 that is configured to attach to a headrest (not shown) of a vehicle. As can be seen from FIG. 7 and FIG. 8, the lock system 203 includes a mounting support 206 configured to be affixed to the first side of the support plate 202; and at least two clip attachments 208 at an end remote from the support plate 202 for attaching to headrest poles (not shown) of a vehicle.

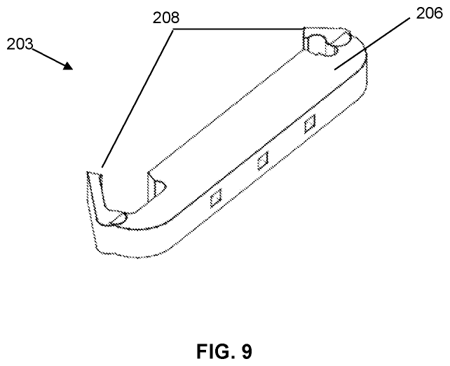

FIG. 9 is an illustrative representation of a mounting support 206 with adjustable clip attachments 208 in accordance with this invention.

In an embodiment, the at least two clip attachments 208 can be actuated between an open position to receive headrest poles of a vehicle and a closed position to securely hold the headrest poles of the vehicle. The clip attachments 208 can be adjustable to allow room for headrest poles with different sizes or different pitch, as shown in FIG. 9.

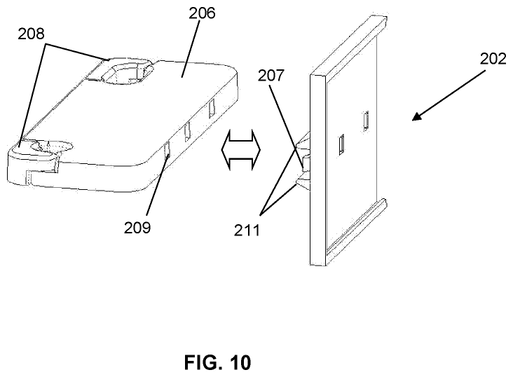

FIG. 10 is an illustrative representation of a support system as shown in FIGS. 7-9, the support system including a support plate 202 further including protrusions 207, such as protruding walls, and a clamping system 211 in accordance with this invention.

The mounting support 206 may be separate from the support plate 202, assembled with, or integral with the support plate 202. In an embodiment as shown in FIG. 10, the first side of the support plate 202 may comprise at least one protrusion 207 and the mounting support 206 may comprise at least one recess 209 in a side thereof facing the first side of the support plate 202 to receive the at least one protrusion 207 such that the mounting support 206 and the support plate 202 can be assembled together.

Preferably, the first side of the support plate 202 can further comprise a clamping system 211 for stabilizing the mounting support 206. For example, the clamping system 211 may comprise two protruding walls in a suitable configuration for clamping, such as parallel to each other, for clamping the mounting support 206 therebetween.

In an aspect, a liquid dispenser apparatus is provided, such as an automated hand sanitizer dispenser apparatus configured for contactless dispensing of a hand sanitizer, the liquid dispenser apparatus comprising a liquid dispenser assembly 201 and the support system configured for attaching to the headrest of a vehicle described herein that is configured for supporting a liquid dispenser assembly 201.

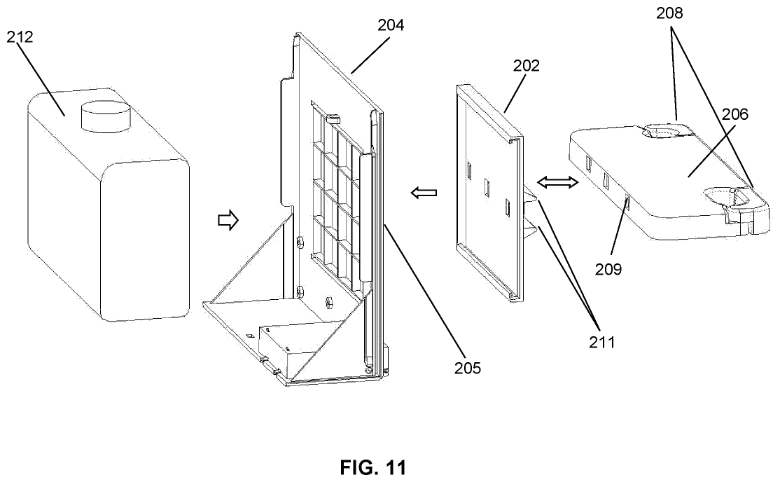

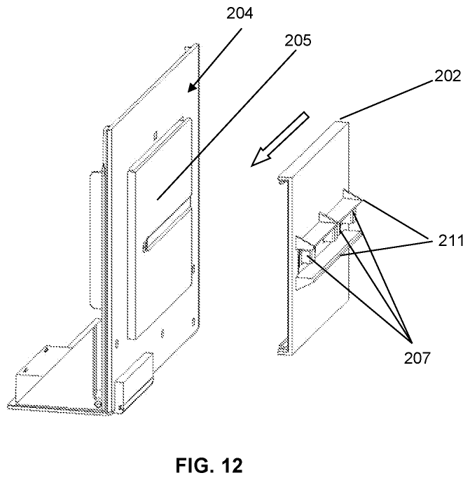

FIG. 11 is an illustrative representation of a frame 204 of a dispenser assembly 201, the frame 204 being configured to support a liquid dispenser tank 212 and being configured to be attached to the support plate 202. FIG. 12 is an illustrative representation of an exemplary embodiment of a frame 204 of a dispenser assembly 201, the frame 204 being configured with a protruding section to be attached to the support plate 202.

In an embodiment, the dispenser assembly 201 may include a frame 204 configured to support a liquid dispenser tank 212, such as an automated hand sanitizer dispenser tank configured for contactless dispensing of a hand sanitizer, the frame 204 being configured to be attached to the support plate 202. A first side of the frame 204 may include at least one protruding section 205 configured to connect to the support plate 202.

The at least one protruding section 205 can be rectangular as shown in FIG. 12 or other suitable shape and can be configured to fit into the support plate.

In an embodiment, the support plate 202 may include a second side opposite the first side, and the second side of the support plate 202 may include at least two lips, for example, an upper lip and a lower lip as shown in FIG. 12, configured to slide onto the protruding section 205 on the frame 204 along the arrow in FIG. 12 such that the lips at least partially surround at least two outer edges of the protruding section 205 for supporting the support plate on the frame 204.

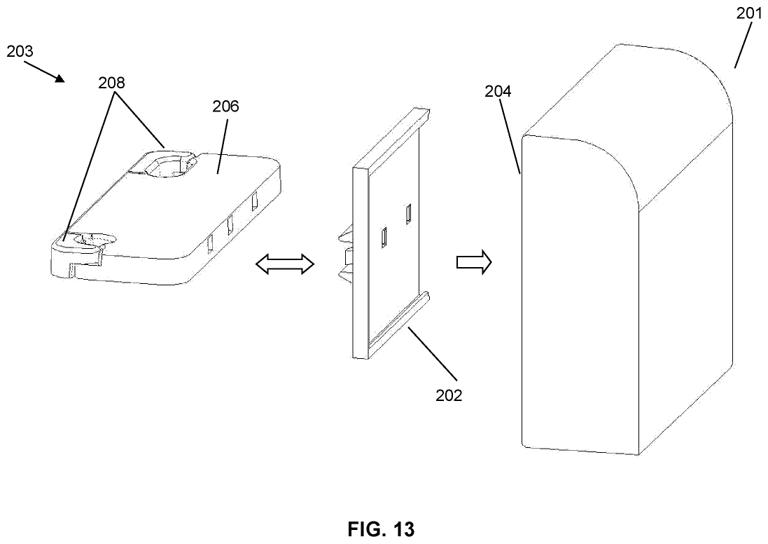

In the embodiment with respect to FIG. 13, a frame 204 of a dispenser assembly 201 may be attached to a support plate 202 and further attached to a lock system 203 to mount onto a car seat headrest, the lock system 203 comprising clip attachments 208 and a mounting support 206.

In an aspect, the liquid dispenser apparatus of the present invention can be an automated hand sanitizer dispenser apparatus configured for contactless dispensing of a hand sanitizer. For example, the dispenser assembly may be configured to include features such as a liquid dispenser tank 212, a dispenser nozzle, a battery pack for providing power to the hand sanitizer dispenser apparatus, a hand sensor, an LED logo light 213 that indicates when the hand sanitizer dispenser apparatus is operational, etc. One or more features of the dispenser assembly may be replaceable features, e.g., replaceable dispenser tanks, replaceable battery packs, etc.

By providing a support system for a liquid dispenser apparatus and/or a liquid dispenser apparatus as described herein with reference to 7-13, the present invention can provide simple and easy installation of a liquid dispenser apparatus in a car seat headrest of a vehicle with superior sanitization and hygiene capability. The support system including a support plate 202 enables a liquid dispenser apparatus as described herein to not require passengers or drivers to touch or hold dispensers in their hand before getting liquids. The support plate 202 is designed to clip onto a car seat headrest of a vehicle. The lock system 203 can support the liquid dispenser apparatus, especially adjustable clip attachments 208 can apply to headrest poles with different sizes to provide support, stability, and controllability of positioning of the liquid dispenser apparatus. Thus, the support system and/or liquid dispenser apparatus of the present invention can avoid disadvantages of the prior art, and can allow for dispensing of liquid, such as hand disinfectant, with less use of hands in handling the liquid dispenser apparatus.

The materials for components of the liquid dispenser apparatuses described herein can be selected from the group consisting of acrylonitrile butadiene styrene (ABS), polymethyl methacrylate (PMMA), silicone, polyurethane, polycarbonate, stainless steel, aluminium, or any other variations known in the art. The manufacturing method may make use of injection molding, rotational molding, compression molding, die casting, laser cutting, 3D printing, or any other variations known in the art.

From the description above follows that, although various embodiments of the invention have been described and shown, the invention is not restricted thereto, but may also be embodied in other ways within the scope of the subject-matter defined in the following claims.

I claim:

1-24. (canceled)

25. A support plate that is configured for supporting a liquid dispenser assembly, characterized in that
a first side of the support plate includes a lever lock system configured to attach to an air vent of a vehicle; the lever lock system including:
a rod protruding from the first side of the support plate;
a hook at an end of the rod remote from the support plate;
a spring that is compressible along the rod towards the support plate; and
a bracket member, wherein the bracket member may be moved along the rod towards and away from the support plate, between an open position wherein the spring is compressed and the bracket member is distant from the hook, and a closed position wherein the bracket member is pushed towards the hook by the spring.

26. The support plate according to claim 25, wherein the hook is configured to attach onto at least one flap of an air vent, and the spring and bracket member are configured such that in the closed position, the spring compresses the bracket member against an opposite side of the at least one flap of the air vent for locking the support plate onto the air vent.

27. The support plate according to claim 25, wherein the hook is integral with the rod.

28. The support plate according to claim 25, wherein the first side of the support plate further comprises at least one pad system for contacting a surface of the vehicle surrounding the air vent and thereby stabilizing the support plate.

29. The support plate according to claim 28, wherein the at least one pad system is adjustable in length in a horizontal direction towards and away from the support plate.

30. The support plate according to claim 29, wherein the at least one pad system comprises a telescoping locking mechanism for adjusting the length of the pad system.

31. A support system that is configured for supporting a liquid dispenser assembly, characterized in that
the support system comprises a support plate having a first side, and a lock system configured to attach to a headrest of a vehicle; the lock system comprising:
a mounting support arranged to be affixed to the first side of the support plate; and
at least two clip attachments on the mounting support at an end remote from the support plate for attaching to headrest poles of a vehicle,
wherein the at least two clip attachments can be actuated between an open position for receiving headrest poles of a vehicle and a closed position for holding securely to the headrest poles of a vehicle.

32. The support system according to claim 31, wherein the at least two clip attachments are adjustable to allow room for headrest poles with different sizes.

33. The support system according to claim 31, wherein the first side of the support plate comprises at least one protrusion and the mounting support comprises at least one recess in a side thereof facing the first side of the support plate to receive the at least one protrusion such that the mounting support can be affixed to the support plate.

34. The support system according to claim 31, wherein the first side of the support plate further comprises a clamping system for stabilizing the mounting support.

35. The support system according to claim 34, wherein the clamping system comprises at least two walls protruding from the first side of the support plate and situated for clamping the mounting support there between.

36. A liquid dispenser apparatus for liquids such as hand sanitizer to attach to the support plate of claim 1, comprising:
a dispenser assembly for dispensing a liquid;
a frame configured to support a liquid dispenser tank, the frame being configured to be attached to the support plate of claim 25.

37. The liquid dispenser apparatus according to claim 36 wherein a first side of the frame includes at least one protruding section configured to connect to the support plate.

38. The liquid dispenser apparatus according to claim 36, wherein the at least one protruding section is rectangular and configured to fit into the support plate.

39. The liquid dispenser apparatus according to claim 38, wherein the support plate includes a second side opposite the first side, and the second side of the support plate includes at least two lips configured to slide onto the protruding section on the frame such that the lips at least partially surround at least two outer edges of the protruding section.

40. A liquid dispenser apparatus for liquids such as hand sanitizer to attach to the system of claim 31, comprising:
a dispenser assembly for dispensing a liquid;
a frame configured to support a liquid dispenser tank, the frame being configured to be attached to the support system of claim 31.

41. The liquid dispenser apparatus according to claim 40 wherein a first side of the frame includes at least one protruding section configured to connect to the support plate of the support system.

42. The liquid dispenser apparatus according to claim 40, wherein the at least one protruding section is rectangular and configured to fit into the support plate of the support system.

43. The liquid dispenser apparatus according to claim 40, wherein the support plate of the support system includes a second side opposite the first side, and the second side of the support plate includes at least two lips configured to slide onto the protruding section on the frame such that the lips at least partially surround at least two outer edges of the protruding section.
